(19) United States
(12) Patent Application Publication
(10) Pub. No.: US 2020/0355303 A1
(43) Pub. Date: Nov. 12, 2020

(54) ARTICULATING ARRANGEMENT FOR PIPE

(71) Applicant: Rolls-Royce Deutschland Ltd & Co KG, Blankenfelde-Mahlow (DE)

(72) Inventors: Paul Julian WELLS, Berlin (DE); Predrag TODOROVIC, Berlin (DE)

(21) Appl. No.: 16/404,962

(22) Filed: May 7, 2019

(51) Int. Cl. F16L 11/18

(52) U.S. Cl. CPC F16L 11/18

(57) ABSTRACT

An articulating arrangement for a pipe includes a narrow section having a diameter D₁ smaller than a diameter D₂; a plurality of slits arranged on the narrow section in a spaced apart manner along a central axis of the pipe, each of the plurality of slits including two or more slit sections separated by two or more bridge sections. The plurality of slits includes a set of first slits and a set of second slits angularly arranged, with respect to the set of first slits, along the central axis. The set of first slits is arranged on a first half of the narrow section and the set of second slits is arranged on a second half of the narrow section. A cover member is arranged on the narrow section to seal the plurality of slits. The cover member diametrically aligns with the diameter D₂.

### TECHNICAL FIELD

The present disclosure relates generally to pipes carrying fluids; and more specifically, to an articulating arrangement for a pipe.

### BACKGROUND

In general, pipes are used for transferring fluids from one point to another. Furthermore, the pipes may be used in various industries, such as in refineries, factories, transportation (for example, jet engines or automobile engines), and so forth. Typically, in such industries an array or a network of pipes (i.e. a piping system) may be used to achieve any specific function, such as heating, cooling or mere transfer of fluid from one point to another. In such piping system, pipes are generally coupled or joined to each other by way of welding, riveting and so forth. Typically, joints in the piping system may be subjected to a higher pressure (due to non-uniform flow of fluid) as compared to other sections (i.e. without joints). Therefore, the joints in the piping system are more prone to the risk of failure, breakage, leakage, and the like. Generally, such problem of the joints may be addressed using expansion joints, which are designed to bear higher pressure and/or torsional twist.

Conventionally, the expansion joints are implemented by way of gimbal expansion joints, which typically includes two spaced apart flanges coupled to each other using connecting links and a bellows section arranged between the flanges and surrounded by the connecting links. However, there are several limitations associated with the use of gimbal expansion joints. For example, the bellows section of a gimbal expansion joint is directly exposed to a fluid flowing through a pipe, which requires restricting a value of maximum flow Mach number associated with the fluid. Furthermore, the surrounding connecting links increases an overall diameter for the gimbal expansion joint, which may not be desirable for implementation in situations where there may be space constraint. Moreover, a large number of components constituting the gimbal expansion joint increases an overall cost and complexity associated with implementation thereof.

Therefore, in light of foregoing discussion, there exists a need to overcome the aforementioned drawbacks associated with conventional expansion joints.

### SUMMARY

The present disclosure seeks to provide an articulating arrangement for a pipe. The present disclosure seeks to provide a solution to the existing problem of joint's strength, space constraint, cost and complexity associated with implementation of conventional expansion joints. An aim of the present disclosure is to provide a solution that overcomes at least partially the problems encountered in prior art, and provides improved joint strength for a pipe in an inexpensive and simple manner and without space constraint.

Embodiments of the present disclosure provide an articulating arrangement for a pipe, the articulating arrangement comprising:

a narrow section having a diameter D₁ smaller than a diameter D₂ of the pipe;

a plurality of slits arranged on the narrow section in a spaced apart manner along a central axis of the pipe, each of the plurality of slits comprises two or more slit sections separated by two or more bridge sections, wherein the plurality of slits comprises a set of first slits and a set of second slits angularly arranged, with respect to the set of first slits, along the central axis, and wherein the set of first slits is arranged on a first half of the narrow section and the set of second slits is arranged on a second half of the narrow section; and

a cover member arranged on the narrow section to seal the plurality of slits, the cover member diametrically aligns with the diameter D₂ of the pipe.

Embodiments of the present disclosure substantially eliminate or at least partially address the aforementioned problems in the prior art, and enables in achieving the improved joint strength for the pipe in inexpensive and simple manner and without the space constraint, by way of having the narrow section in the pipe with the plurality of slits thereon and the cover member sealing such slits.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a perspective view of an articulating arrangement for a pipe, in accordance with an embodiment of the present disclosure;

FIG. 2 illustrates a perspective view of a narrow section of the articulating arrangement of FIG. 1, in accordance with an embodiment of the present disclosure;

FIGS. 3, 4 and 5 illustrate perspective views of narrow sections for an articulating arrangement, in accordance with various embodiments of the present disclosure; and

FIG. 6 illustrates the articulating arrangement of FIG. 1 with a protective layer, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

Embodiments of the present disclosure provide an articulating arrangement for a pipe, the articulating arrangement comprising:

a narrow section having a diameter D₁ smaller than a diameter D₂ of the pipe;

a plurality of slits arranged on the narrow section in a spaced apart manner along a central axis of the pipe, each of the plurality of slits comprises two or more slit sections separated by two or more bridge sections, wherein the plurality of slits comprises a set of first slits and a set of second slits angularly arranged, with respect to the set of first slits, along the central axis, and wherein the set of first slits is arranged on a first half of the narrow section and the set of second slits is arranged on a second half of the narrow section; and

a cover member arranged on the narrow section to seal the plurality of slits, the cover member diametrically aligns with the diameter D2 of the pipe.

The aforesaid articulating arrangement for the pipe provides flexibility and resilient joint-support for a pipe. The articulating arrangement enables in bearing high (and/or non-uniform) pressure, lateral and longitudinal expansion, and/or torsional twist, which may be caused due to non-uniform flow of fluid through the pipe. Further, the articulating arrangement enables a pipe to carry a fluid, which may be associated with higher flow Mach number because the narrow section along with the cover member provides improved strength for handling circumferential pressure (i.e. lateral expansion) or axial load (longitudinal expansion) generated due to uneven flow of the fluid. The articulating arrangement further enables in maintaining a uniform diameter for the pipe, and thereby allowing the pipe to be used in areas where there may be space constraint. Moreover, the articulating arrangement of the present disclosure is constituted using lesser number of components and thereby reducing an overall cost and complexity associated with implementation thereof.

Throughout the present disclosure the term “pipe” relates to a tubular or a cylindrical element, used for carrying or transferring a fluid from one point to another. It may be appreciated that the pipe may include a cross-section other than circular, such as oval or polygonal. Optionally, the pipes may be manufactured using metals, plastic, rubber or any combination thereof.

Throughout the present disclosure the term “articulating arrangement” relates to an expansion joint used for coupling or attaching the pipes. It may be appreciated that the articulating arrangement may be used in conjunction with pipes apart from being a joint, for example, the articulating arrangement may be used at bents or turns of the pipes. The articulating arrangement provides an adaptive linkage that provides a flexible support between the pipes, i.e. the articulating arrangement enables in bearing high (and/or non-uniform) pressure, lateral and longitudinal expansion, and/or torsional twist, which may be caused due to non-uniform flow of fluid through the pipe. It will be appreciated that the term “flexible support” used herein relates to the ability to resist any permanent deformation and/or regaining original shape after removal of load (i.e. the pressure generated within the pipe with the flow of the fluid).

The articulating arrangement comprises the narrow section having the diameter D₁ smaller than the diameter D₂ of the pipe. It will be appreciated that the term “narrow section” used herein relates to a portion of the pipe, having a smaller diameter as compared to an overall diameter of the pipe. Optionally, the narrow section has a diameter D₁ in a range of 0.6 to 0.9 times of the diameter D₂ of the pipe. In an example, the narrow section may have a diameter D₁ in a range starting from 0.60, 0.65, 0.70, 0.75, 0.80, 0.85 up to 0.70, 0.75, 0.80, 0.85, 0.90, 0.95 times of the diameter D₂ of the pipe. Further, a length of the narrow section may constitute 2 percent to 10 percent of the length of the pipe.

In an embodiment, the thickness T₁ of the narrow section is greater than a thickness T₂ of the pipe. Optionally, the narrow section has a thickness T₁ in a range of 1.05 to 1.3 times of the thickness T₂ of the pipe. In an example, the narrow section may have a thickness T₁ in a range starting from 1.05, 1.10, 1.15, 1.20, 1.25 up to 1.10, 1.15, 1.20, 1.25, 1.30 times of the thickness T₂ of the pipe. It will be appreciated that due to smaller diameter D₁ of the narrow section, pressure of the fluid flowing through the narrow section may be higher than the pressure at other sections of the pipe having the diameter D₂. Therefore, higher thickness T₁ allows the narrow section to accommodate higher or increased pressure caused due to the smaller diameter D₁ of the narrow section.

In one embodiment, the articulating arrangement includes connecting members that integrates the narrow section, having the diameter D₁, with the pipe having the diameter D₂. In an example, the connecting members may be tapered sections extending from ends of the narrow section and integrating with the pipe. Alternatively, the connecting members may be flat circular structure (having through hole of diameter D₁) extending from ends of the narrow section and integrating with the pipe.

The articulating arrangement comprises the plurality of slits arranged on the narrow section in a spaced apart manner along a central axis of the pipe, each of the plurality of slits comprises two or more slit sections separated by two or more bridge sections. The term “slits” used herein relates to long, thin and through circumferential cuts or openings configured on the narrow section. Alternatively, the slits may include circumferential cutout-sections having at least one of a circular shape, an oval shape, a polygonal shape or any combination thereof. Notably, the arrangement of the plurality of slits is obtained with reference to the central axis. The central axis is an imaginary line passing through the center of the pipe, and perpendicular to a cross-section plane of the pipe.

According to an embodiment, adjacent slits of the plurality of slits are placed at a predefined distance to each other. Specifically, a pair of adjacent slits is separated by a spacer arranged there-between. It will be appreciated that based on a width of the spacer the predefined distance between adjacent slits may alter. In an example, the adjacent slits are placed equidistantly to each other, i.e. when spacers there-between have a uniform width. In another example, the adjacent slits are placed at a varying distance from each other, i.e. when spacers there-between have a non-uniform width.

The each of the plurality of slits comprises two or more slit sections separated by two or more bridge sections. It will be appreciated that bridge sections provide linkage or connection between adjacent spacers in addition to separating the slit sections. In an example, each slit includes two slit sections separated by two bridge sections. Specifically, when each slit includes two slit sections, the two slit sections cover a substantial circumferential length of two semi-circular halves of the narrow section, and separated by two bridge sections. Alternatively, the each of the plurality of slits may include multiple slit sections (for example, three slit sections, four slit sections and the like) separated by multiple bridge sections (for example, three bridge sections, four bridge sections and the like). Furthermore, in an example, each slit section may include identical shape. In another example, few slit sections may include identical shape and remaining slit sections may include non-identical shape.

Optionally, the predefined distance between the adjacent slits (i.e. the width of the spacer between the adjacent slits) defines an extent of bending (or flexibility) of the narrow section. For example, a larger predefined distance between the adjacent slits (or larger spacer's width) may provide more bending ability to the narrow section, as compared to smaller predefined distance between the adjacent slits (or smaller spacer's width). Also, a number of slits present on the narrow section will also affect the bending ability of the narrow section. Therefore, it will be appreciated that based on a required bending ability (or flexibility) of the narrow section, the numbers of slits and the predefined distance there-between may be defined or selected.

Optionally, planes carrying the plurality of slits are arranged perpendicular or at an inclined angle to the central axis. It will be appreciated that when the planes carrying the plurality of slits are arranged perpendicular to the central axis, a circumferential plane of the narrow section is parallel to the planes carrying the plurality of slits. Similarly, when the planes carrying the plurality of slits are arranged at the inclined angle to the central axis, the circumferential plane of the narrow section is at the inclined angle to the planes carrying the plurality of slits. In an example, the planes carrying the plurality of slits may be arranged at an inclined angle (ranging from 5 degrees to 45 degrees) with respect to the circumferential plane.

The plurality of slits comprises a set of first slits and a set of second slits angularly arranged, with respect to the set of first slits, along the central axis. In an example, the set of first slits and the set of second slits may relate to a group of slits having same shape and dimension. However, angular orientation of the set of first slits is different from the set of second slits with respect to and along the central axis. For example, the set of first slits may be defined as a sector of the circumferential wall covering an angular distance (for example 10 degrees to 80 degrees, based on a size of the bridge section between slit sections) with respect to a horizontal diametrical plane. Further, the set of second slits may be defined as a sector of the circumferential wall covering an angular distance (for example 280 degrees to 80 degrees) with respect to the horizontal diametrical plane.

The set of first slits is arranged on a first half of the narrow section and the set of second slits is arranged on a second half of the narrow section. The term first half and the second half relate to longitudinal halves of the narrow section. Therefore, the set of first slits is collectively present at one longitudinal half of the narrow section, and the set of second slits is collectively present at another or second longitudinal half of the narrow section.

In an embodiment, the set of first slits and the set of second slits are separated by an intermediate spacer. In an example, a width of the intermediate spacer is larger as compared to spacers typically separating adjacent slits. It will be appreciated that when the narrow section is subjected to high pressure, the set of first slits may allow the narrow section to move laterally upward and downward, and the set of second slits may allow the narrow section to move longitudinally forward and backward. This may allow the narrow section to accommodate the axial load (which may be exerted by the fluid) without allowing the narrow section to extend or lengthen. This further enables in reducing a cyclic load and fatigue subjected to the narrow section.

Optionally, slits of the set of first slits and the set of second slits are arranged alternatively. In other words, a given first slit (of the set of first slits) is adjacently arranged to a given second slit (of the set of second slits); or in a pair of adjacent slits one slit is selected from the set of first slits and another slit is selected from the set of second slits. Further, in such an instance the narrow section may not include an intermediate spacer, described herein above.

According to an embodiment, the plurality of slits on the narrow section may be obtained through various machining processes or moulding processes. Furthermore, the machining processes may include drilling, cutting, and a combination thereof.

The articulating arrangement comprises the cover member arranged on the narrow section to seal the plurality of slits, the cover member diametrically aligns with the diameter D₂ of the pipe. The term “cover member” used herein relates to an outer surrounding layer that substantially covers the narrow section, i.e. at least the plurality of slits that are present on the narrow section. In an example, the cover member is a bellows having a wavy peripheral structure (i.e. having a crest and a trough). Alternatively, the cover member may be a cylindrical structure having a uniform peripheral thickness. However, in such instance (when the cover member includes uniform peripheral thickness) the cover member may be made of a material that is more flexible and/or elastic as compared to a material that forms the narrow section. This will allow the narrow section with the cover member (arranged thereon) to bend with high and/or non-uniform pressure.

According to an embodiment, the cover member would contact with the fluid flowing through the pipe because of the plurality of slits present on the narrow section. This will enable the pipe with the articulating arrangement to carry fluid associated with higher flow Mach number, because the narrow section along with the cover member (such as the bellows) provides improved strength (compared to conventional expansion joint having only bellows) for handling circumferential pressure or load generated due to the flow of the fluid through the pipe.

According to an embodiment, the cover member may be manufactured using semi-hardened materials such as thin metal sheets, metal alloys sheets and the like. Alternatively, the cover member may be manufactured using plastic, rubber or any combination of metal and plastic or rubber.

As mentioned herein above, the cover member diametrically aligns with the diameter D₂ of the pipe, i.e. an outer diameter of the cover member diametrically aligns with the diameter D₂ of the pipe. In simple words, a thickness of the cover member may be a difference between the diameter D₂ of the pipe and the diameter D₁ of the narrow section. This enables in maintaining a uniform diameter for the pipe even with articulating arrangement arranged thereon. This further enables the pipe with the articulating arrangement to be used in situations where there may be space constraint.

Optionally, the articulating arrangement further comprises a protective layer enclosing at least the cover member. The protective layer may be a temperature resistant cover that protects the cover member from harsh weather conditions, i.e. when subjected to high or low temperature conditions. The protective layer may also act as an insulating layer that enables in containing heat of the fluid inside the pipe, to maintain a required temperature for the fluid flowing through the pipe. The protective layer may run along an entire length of the pipe or may be arranged to only enclose the cover member. In first case, when the protective layer runs along the entire length of the pipe, the protective layer may include a flexible section (for example, a braided section of a metal pipe) that encloses the cover member. In second case, when the protective layer runs only along a length of the cover member, the protective layer may be an additional flexible cylindrical cover that encloses the cover member. In both the cases the protective layer apart from providing safety to the cover member also allows the articulating arrangement to accommodate bending, when subjected to high and/or non-uniform pressure. The protective layer may be made of any suitable material, which may include but not limited to metal, plastic, rubber or any combination thereof.

Optionally, the articulating arrangement may be used in conjunction with pipes that are utilized in various industries, such as oil and gas refineries, industries, engines such as jet engines or automobile engines, and the like. In an example, the pipes may be implemented in an environmental control system of a jet engine, which includes pipes for transferring of fluids such as gases, smoke and the like.

### DETAILED DESCRIPTION OF THE DRAWINGS

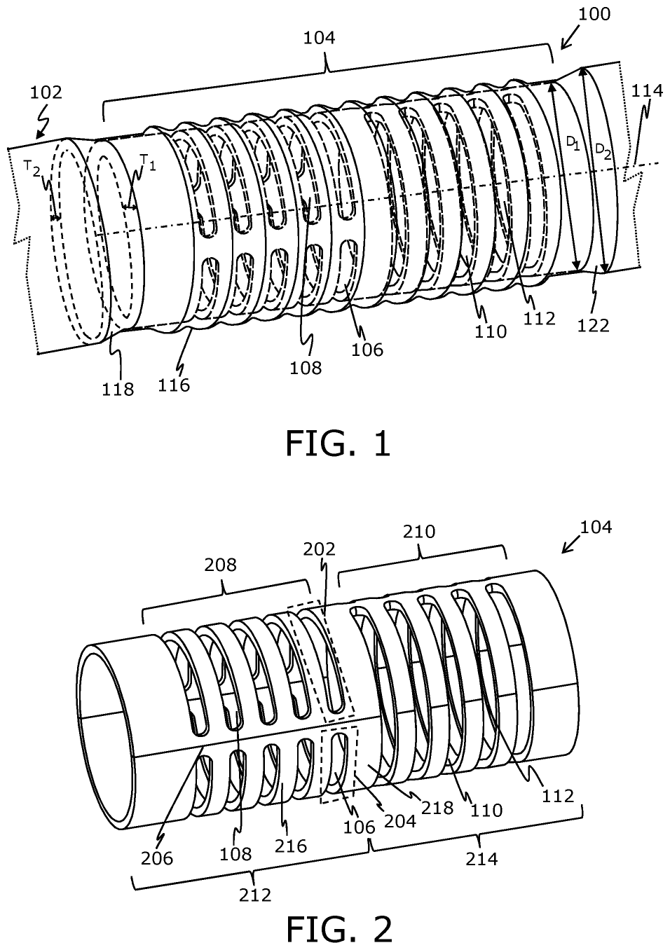

Referring to FIG. 1, illustrated is a perspective view of an articulating arrangement 100 for a pipe 102, in accordance with an embodiment of the present disclosure. As shown, the articulating arrangement 100 includes a narrow section 104 having a diameter D₁ smaller than a diameter D₂ of the pipe 102. The articulating arrangement 100 also includes a plurality of slits, such as slits 106, 108, 110 and 112, arranged on the narrow section 104 in a spaced apart manner along a central axis 114 of the pipe 102. The articulating arrangement 100 further includes a cover member 116 arranged on the narrow section 104 to seal the plurality of slits 106, 108, 110, 112. The cover member 116 diametrically aligns with the diameter D₂ of the pipe 102. FIG. 1 also depicts a thickness T₁ of the narrow section 104 greater than a thickness T₂ of the pipe 102; and connecting members 118 that integrates the narrow section 104 (having the diameter D₁) with the pipe 102 (having the diameter D₂).

Referring to FIG. 2 illustrated is a perspective view of the narrow section 104 of the articulating arrangement 100 of FIG. 1, in accordance with an embodiment of the present disclosure. As shown, the narrow section 104 includes the slits 106, 108, 110 and 112. Further, each of the plurality of slits, such as the slit 106, includes two or more slit sections, such as slit sections 202 and 204, separated by two or more bridge sections, such as a bridge section 206. Moreover, the plurality of slits (such as the slits 106, 108, 110 and 112) includes (or segregated as) a set of first slits 208 and a set of second slits 210 angularly arranged, with respect to the set of first slits 208, along the central axis 114. As shown, the set of first slits 208 is arranged on a first half 212 of the narrow section 104, and the set of second slits 210 is arranged on a second half 214 of the narrow section 104. As shown, adjacent slits (such as the slits 106, 108 of the set of first slits 208, and the slits 110, 112 of the set of second slits 210) are separated by spacers 216 arranged there-between. FIG. 2 also depicts, an intermediate spacer 218 arranged between the set of first slits 208 and the set of second slits 210.

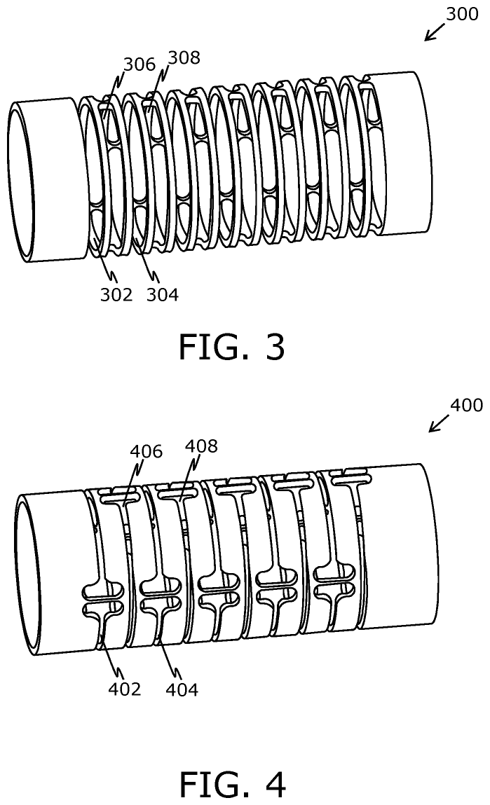

Referring to FIGS. 3, 4 and 5, illustrated are perspective views of narrow sections 300, 400, and 500 for an articulating arrangement, such as the articulating arrangement 100 of FIG. 1, in accordance with various embodiments of the present disclosure. It will be appreciated that the narrow sections 300, 400, and 500 are similar to the narrow section 104 of FIG. 2, for example each of the that narrow sections 300, 400, 500 includes a plurality of slits, and a smaller diameter and a greater thickness as compared to a pipe. As shown in FIG. 3, the narrow section 300 includes a plurality of slits 302, 304, 306 and 308. However, the plurality of slits 302, 304, 306, 308 includes (or segregated as) a set of first slits, such as the slits 302, 304, and a set of second slits, such as the slits 306, 308, i.e. the slits from the set of first slits 302, 304 and the set of second slits 306, 308 are arranged alternatively.

As shown in FIG. 4, the narrow section 400 also includes a plurality of slits 402, 404, 406 and 408. The plurality of slits 402, 404, 406 408 includes (or segregated as) a set of first slits, such as the slits 402, 404, and a set of second slits, such as the slits 406, 408. Further, the slits from the set of first slits 402, 404 and the set of second slits 406, 408 are arranged alternatively.

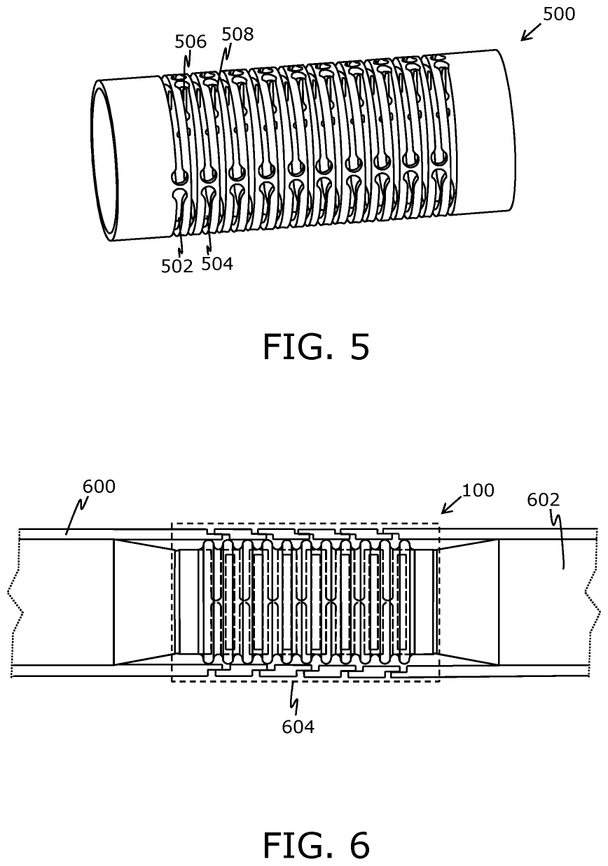

Similarly, as shown in FIG. 5, the narrow section 500 also includes a plurality of slits 502, 504, 506 and 508. The plurality of slits 502, 504, 506, 508 includes (or segregated as) a set of first slits, such as the slits 502, 504, and a set of second slits, such as the slits 506, 508. Further, the slits from the set of first slits 502, 504 and the set of second slits 506, 508 are arranged alternatively. It will be appreciated that the narrow sections 300, 400, 500 of the FIGS. 3, 4 and 5 are various exemplary designs for the plurality of slits (such as slits 302-308, 402-408, and 502-508) configured on the narrow sections 300, 400, 500, respectively. Therefore, FIGS. 3, 4 and 5 are merely examples, which should not unduly limit the scope of the claims herein.

Referring to FIG. 6, illustrated is the articulating arrangement 100 of FIG. 1 with a protective layer 600, in accordance with an embodiment of the present disclosure. As shown, the protective layer 600 runs along a length of the pipe 602. The protective layer includes a flexible section 604, such as a braided section.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. An articulating arrangement for a pipe, the articulating arrangement comprising:
a narrow section having a diameter D₁ smaller than a diameter D₂ of the pipe;
a plurality of slits arranged on the narrow section in a spaced apart manner along a central axis of the pipe, each of the plurality of slits comprises two or more slit sections separated by two or more bridge sections, wherein the plurality of slits comprises a set of first slits and a set of second slits angularly arranged, with respect to the set of first slits, along the central axis, and wherein the set of first slits is arranged on a first half of the narrow section and the set of second slits is arranged on a second half of the narrow section; and
a cover member arranged on the narrow section to seal the plurality of slits, the cover member diametrically aligns with the diameter D₂ of the pipe.

2. The articulating arrangement of claim 1, wherein a thickness T₁ of the narrow section is greater than a thickness T₂ of the pipe.

3. The articulating arrangement of claim 1, further comprising a protective layer enclosing at least the cover member.

4. The articulating arrangement of claim 1, wherein planes carrying the plurality of slits are arranged perpendicular or at an inclined angle to the central axis.

5. The articulating arrangement of claim 1, wherein the cover member is designed as substantially cylindrical structure.

6. The articulating arrangement of claim 1, wherein the cover member is designed as bellows.

7. The articulating arrangement according to claim 1, wherein the cover member has a uniform peripheral thickness.

8. The articulating arrangement according to claim 7, wherein the cover member is made of a material that is more flexible and/or elastic as compared to a material that forms the narrow section.
